(19) United States
(12) Patent Application Publication
(10) Pub. No.: US 2019/0346038 A1
(43) Pub. Date: Nov. 14, 2019

(54) HYDRAULIC CIRCUIT

(71) Applicant: KOMATSU LTD., Tokyo (JP)

(72) Inventors: Kei OMAE, Minato-ku, Tokyo (JP); Masaki SHIOHARA, Minato-ku, Tokyo (JP)

(21) Appl. No.: 16/475,787

(22) PCT Filed: Mar. 13, 2018
(86) PCT No.: PCT/JP2018/009658

§ 371 Date: Jul. 3, 2019

(30) Foreign Application Priority Data
Mar. 14, 2017 (JP) 2017-048779

(51) Int. Cl. F16H 57/04; F01M 1/02; F01M 5/00; F01M 11/02; F01M 11/10; F01M 11/08; F16N 7/40; F16N 21/00; F16N 29/00; F16N 39/02; F16N 39/06

(52) U.S. Cl. CPC F16H 57/0402; F16D 65/853; F16H 57/0415; F16H 57/042; F16H 57/0436; F01M 1/02; F01M 5/002; F01M 11/02; F01M 11/10; F01M 11/08; F16N 7/40; F16N 21/00; F16N 29/00; F16N 39/02; F16N 39/06; F16H 57/0405

(57) ABSTRACT

A hydraulic circuit includes a hydraulic pump configured to supply lubricating oil, a resisting apparatus configured to maintain an oil pressure of the lubricating oil supplied from the hydraulic pump, an oil supply channel configured to guide the lubricating oil from the hydraulic pump to the resisting apparatus, and an optical detector configured to measure a degree of contamination of the lubricating oil flowing through the oil supply channel.

### CROSS-REFERENCE TO RELATED APPLICATIONS

This application is a U.S. National stage application of International Application No. PCT/JP2018/009658, filed on Mar. 13, 2018. This U.S. National stage application claims priority under 35 U.S.C. § 119(a) to Japanese Patent Application No. 2017-048779, filed in Japan on Mar. 14, 2017, the entire contents of which are hereby incorporated herein by reference.

### BACKGROUND

### Field of the Invention

The present invention relates to a hydraulic circuit.

### Background Information

Conventionally, work vehicles such as a dump truck, a wheel loader, or the like are provided with a hydraulic circuit for supplying lubricating oil to hydraulic equipment such as the transmission, the brakes, or the like (for example, see Japanese Patent Laid-open No. 2013-234751 and Japanese Patent Laid-open No. 2013-091491).

### SUMMARY

However, foreign matter such as metal abrasion powder may become mixed with the lubricating oil flowing through the hydraulic circuit, and such type of foreign matter can cause a breakdown of the hydraulic equipment or abnormal wear and the like.

Accordingly, there is a need to measure the degree of contamination of the lubricating oil due to foreign matter being mixed therein by using an optical detector that can easily and with relatively high accuracy detect foreign matter mixed into the lubricating oil.

For example, it is possible to install an optical detector in a lubricating oil tank and detect foreign matter mixed in the lubricating oil that is stored in the lubricating oil tank. However, air bubbles may be mixed into the lubricating oil stored in the lubricating oil tank, and because the air bubbles may be mistakenly detected as foreign matter even while the optical detector is attempting to detect foreign matter, the degree of contamination of the lubricating oil cannot be measured accurately.

In consideration of the above situation, an object of the present invention is to provide a hydraulic circuit that can accurately measure the degree of contamination of lubricating oil.

A hydraulic circuit according to a first aspect has a hydraulic pump, a resisting apparatus, an oil supply channel, and an optical detector. The hydraulic pump supplies lubricating oil. The resisting apparatus maintains the oil pressure of the lubricating oil supplied from the hydraulic pump. The oil supply channel guides the lubricating oil from the hydraulic pump to the resisting apparatus. The optical detector measures the degree of contamination of the lubricating oil flowing through the oil supply channel.

According to the hydraulic circuit according to the first aspect, the optical detector measures the degree of contamination of the lubricating oil flowing through the oil supply channel for guiding the lubricating oil from the hydraulic pump to the resisting apparatus. Air bubbles in the lubricating oil flowing through the oil supply channel are removed by the hydraulic pump. Therefore, the degree of contamination of the lubricating oil can be measured accurately because the false detection of air bubble as foreign matter in the lubricating oil by the optical detector can be suppressed.

A hydraulic circuit according to a second aspect has a lubricating oil filter disposed in the oil supply channel. The optical detector is positioned on the upstream side of the lubricating oil filter.

According to the hydraulic circuit according to the second aspect, the mixed amount of foreign matter in the lubricating oil can be understood precisely because the optical detector is able to measure the degree of contamination of the lubricating oil that has not been filtered by the lubricating oil filter. As a result, the degree of contamination of the lubricating oil can be measured with even greater accuracy.

In a hydraulic circuit according to a third aspect, the resisting apparatus is a hydraulic apparatus that agitates the lubricating oil on the inside thereof.

According to the hydraulic circuit according to the third aspect, the optical detector is disposed upstream of the hydraulic apparatus that agitates the lubricating oil on the inside thereof. Therefore, the degree of contamination of the lubricating oil can be measured with even greater accuracy because foreign matter in the lubricating oil can be detected before the lubricating oil is agitated by the hydraulic apparatus.

In a hydraulic circuit according to a fourth aspect, the resisting apparatus is a hydraulic transmission.

According to the present invention, a hydraulic circuit is provided that can measure the degree of contamination of lubricating oil accurately.

### BRIEF DESCRIPTION OF DRAWINGS

FIG. 1 is a block diagram illustrating a configuration of a hydraulic circuit according to a first embodiment.

FIG. 2 is a block diagram illustrating a configuration of a hydraulic circuit according to a second embodiment.

FIG. 3 is a block diagram illustrating a configuration of a hydraulic circuit according to a third embodiment.

### DETAILED DESCRIPTION OF EMBODIMENT(S)

### 1. First Embodiment

### Configuration of Hydraulic Circuit 10

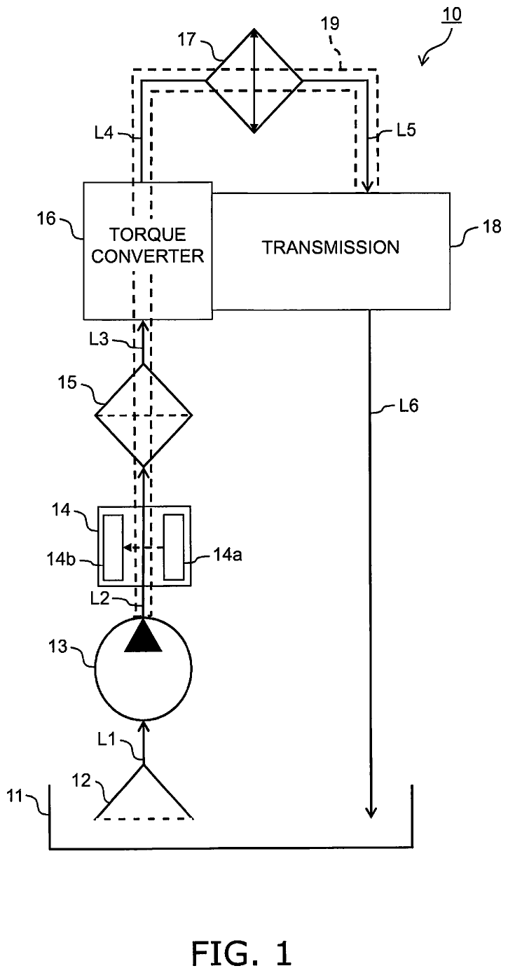

A configuration of a hydraulic circuit 10 according to a first embodiment will be explained with reference to FIG. 1. The hydraulic circuit 10 supplies lubricating oil to a transmission 18 of a work vehicle. A dump truck, a grader, a wheel loader, and a bulldozer and the like may be included as the work vehicle.

The hydraulic circuit 10 is provided with a lubricating oil tank 11, a suction filter 12, a hydraulic pump, an optical detector 14, a lubricating oil filter 15, a torque converter 16, a cooler 17, a transmission 18, and conduits L1 to L6.

In the present embodiment, the conduits L2 to L5, the lubricating oil filter 15, the torque converter 16, and the cooler 17 configure an “oil supply channel 19” for guiding the lubricating oil from the hydraulic pump 13 to the transmission 18. The oil pressure of the lubricating oil is maintained in the oil supply channel 19, and pressure is applied to the lubricating oil flowing through the oil supply channel 19 by the belowmentioned hydraulic pump 13.

The lubricating oil tank 11 stores the lubricating oil. The suction filter 12 is disposed in the lubricating oil stored in the lubricating oil tank 11. The suction filter 12 filters out foreign matter (relatively large metal abrasion powder and the like) mixed into the lubricating oil. The mesh of the suction filter 12 can be set to a size that does not interfere with the flow of the lubricating oil.

The hydraulic pump 13 is connected to the suction filter 12 via the conduit L1. The hydraulic pump 13 is driven by rotational power from an unillustrated engine. The hydraulic pump 13 supplies the lubricating oil. Specifically, the hydraulic pump 13 sucks in the lubricating oil from the lubricating oil tank 11 side and the lubricating oil is compressed inside the hydraulic pump 13, and thereafter the lubricating oil is discharged toward the optical detector 14. The lubricating oil discharged by the hydraulic pump 13 is guided through the oil supply channel 19 to the transmission 18.

While air bubbles may become included in the lubricating oil sucked in by the hydraulic pump 13, the air bubbles are removed from the lubricating oil when the lubricating oil is compressed inside the hydraulic pump 13. In the present description, “the air bubbles are removed from the lubricating oil” does not signify that the air bubbles are completely removed from the lubricating oil, but signifies that minute or very small air bubbles of a size that cannot be falsely detected as foreign matter by the belowmentioned optical detector 14 may be included in the lubricating oil.

A fixed displacement pump may be used as the hydraulic pump 13.

The optical detector 14 is disposed in the oil supply channel 19. Therefore, the optical detector 14 is positioned on the downstream side of the hydraulic pump 13 and on the upstream side of the transmission 18. That is, the optical detector 14 is disposed between the hydraulic pump 13 and the transmission 18 in the hydraulic circuit 10. In the present embodiment, the optical detector 14 is disposed on the conduit L2 that connects the hydraulic pump 13 and the lubricating oil filter 15.

The optical detector 14 measures the degree of contamination of the lubricating oil flowing through the oil supply channel 19 (specifically, the conduit L2). The optical detector 14 has a light projecting part 14a that emits light (for example, laser light) onto the lubricating oil, and a light receiving part 14b to which the emitted light from the light projecting part 14a is incident. The optical detector 14 measures the degree of contamination of the lubricating oil on the basis of the degree that the emitted light is blocked by foreign matter in the lubricating oil. Specifically, the optical detector 14 measures the degree of contamination of the lubricating oil on the basis of the light intensity reduction rate of the incident light on the light receiving part 14b with respect to the emitted light from the light projecting part 14a.

Here, air bubbles in the lubricating oil flowing through the oil supply channel 19 have been removed by the hydraulic pump 13 as indicated above and the lubricating oil has not been agitated by the belowmentioned transmission 18. Therefore, the degree of contamination of the lubricating oil can be measured accurately because the false detection of the air bubbles as foreign matter in the lubricating oil by the optical detector can be suppressed.

In addition, in the present embodiment, the optical detector 14 is positioned on the upstream side of the lubricating oil filter 15. That is, the optical detector 14 is disposed between the hydraulic pump 13 and the lubricating oil filter 15 in the hydraulic circuit 10. Therefore, the mixed amount of foreign matter in the lubricating oil can be understood precisely because the optical detector 14 is able to measure the degree of contamination of the lubricating oil that has not been filtered by the lubricating oil filter 15. As a result, the degree of contamination of the lubricating oil can be measured with even greater accuracy.

The lubricating oil filter 15 is connected to the hydraulic pump 13 via the conduit L2. The lubricating oil filter 15 filters out foreign matter (relatively large metal abrasion powder and the like) mixed into the lubricating oil. The mesh of the lubricating oil filter 15 may be smaller than the mesh of the suction filter 12.

The torque converter 16 is connected to the lubricating oil filter 15 via the conduit L3. The torque converter 16 transmits rotational power from the engine to the transmission 18.

The cooler 17 is connected to the torque converter 16 via the conduit L4. The cooler 17 cools the lubricating oil that has been heated by the torque converter 16. For example, the cooler 17 cools the lubricating oil by receiving an air flow from a cooling fan.

The transmission 18 is connected to the cooler 17 via the conduit L5. The transmission 18 is positioned on the downstream side of the hydraulic pump 13 and the optical detector 14.

The transmission 18 changes the speed of the rotational power from the engine transmitted by the torque converter 16 and transmits driving power to an unillustrated travel device. The transmission 18 has a forward travel gear that corresponds to a forward travel stage, a reverse travel gear that corresponds to a reverse travel stage, and one or more velocity stage gears that correspond to respective velocity stages. In the transmission 18, changing the speed is carried out due to the selective engagement of each of the gears in response to the traveling direction, a desired driving power, or a desired velocity.

Lubricating oil is supplied to each of the gears of the transmission 18 from the oil supply channel 19 (specifically, the conduit L5). The lubricating oil is agitated by the gears. At this time, air bubbles are generated in the lubricating oil and the lubricating oil becomes clouded. The clouded lubricating oil is returned to the lubricating oil tank 11 via the conduit L6.

In the lubricating oil supplied from the oil supply channel 19 to the transmission 18, the oil pressure applied by the hydraulic pump 13 is maintained. However, in the lubricating oil flowing out from the transmission 18 to the conduit L6, the oil pressure applied by the hydraulic pump 13 is not maintained and the lubricating oil is in a pressure released state. The transmission 18 is an example of a “resisting apparatus” that maintains the oil pressure of the lubricating oil supplied from the hydraulic pump 13. In addition, the transmission 18 is an example of a “hydraulic apparatus” that agitates, on the inside thereof, the lubricating oil supplied from the hydraulic pump 13.

Air bubbles are mixed into the lubricating oil discharged from the transmission 18 to the conduit L6, and while air bubbles may be further mixed into the lubricating oil when returned to the lubricating oil tank 11, thereafter the air bubbles in the lubricating oil are removed when the lubricating oil is compressed by the hydraulic pump 13.

### Characteristics

In the hydraulic circuit 10 according to the first embodiment, the optical detector 14 measures the degree of contamination of the lubricating oil flowing through the oil supply channel 19 for guiding the lubricating oil from the hydraulic pump 13 to the transmission 18. The oil pressure of the lubricating oil flowing through the oil supply channel 19 is maintained by the transmission 18 as a resisting apparatus. As a result, the state in which the air bubbles are removed by the hydraulic pump 13 from the lubricating oil flowing through the oil supply channel 19 is maintained. Therefore, the degree of contamination of the lubricating oil can be measured accurately because the false detection of the air bubbles as foreign matter in the lubricating oil by the optical detector can be suppressed.

(2) In the hydraulic circuit 10 according to the present embodiment, the optical detector 14 is positioned on the upstream side of the lubricating oil filter 15. Therefore, the mixed amount of foreign matter in the lubricating oil can be understood precisely because the optical detector 14 is able to measure the degree of contamination of the lubricating oil that has not been filtered by the lubricating oil filter 15. As a result, the degree of contamination of the lubricating oil can be measured with even greater accuracy.

(3) The optical detector 14 is disposed upstream of the transmission 18 that agitates the lubricating oil on the inside thereof. Therefore, the degree of contamination of the lubricating oil can be measured with even greater accuracy because foreign matter in the lubricating oil can be detected before the lubricating oil is agitated by the transmission 18.

### 2. Second Embodiment

### Configuration of Hydraulic Circuit 20

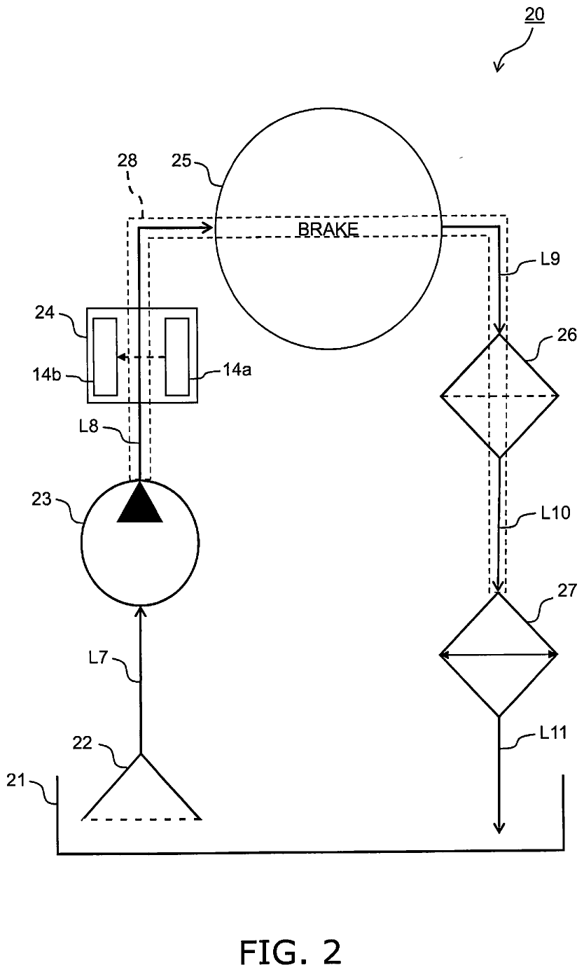

A configuration of a hydraulic circuit 20 according to a second embodiment is explained with reference to FIG. 2. The hydraulic circuit 20 is for supplying lubricating oil to a brake 25 of a work vehicle.

The hydraulic circuit 20 is provided with a lubricating oil tank 21, a suction filter 22, a hydraulic pump 23, an optical detector 24, a brake 25, a lubricating oil filter 26, a cooler 27, and conduits L7 to L11. In the present embodiment, the conduits L8 to L10, the brake 25, and the lubricating oil filter 26 configure an “oil supply channel 28” for guiding lubricating oil from the hydraulic pump 23 to the brake 25. The oil pressure of the lubricating oil is maintained in the oil supply channel 28, and pressure is applied to the lubricating oil flowing through the oil supply channel 28 by the belowmentioned hydraulic pump 23.

The configurations of the lubricating oil tank 21 and the suction filter 22 are the same as the respective lubricating oil tank 11 and the suction filter 12 according to the first embodiment.

The hydraulic pump 23 is connected to the suction filter 22 via the conduit L7. The hydraulic pump 23 is driven by rotational power from an unillustrated engine. The hydraulic pump 23 supplies the lubricating oil. Specifically, the hydraulic pump 23 sucks in the lubricating oil from the lubricating oil tank 21 side and the lubricating oil is compressed inside the hydraulic pump 23, and thereafter the lubricating oil is discharged toward the optical detector 24. The lubricating oil discharged from the hydraulic pump 23 is guided to the brake 25 through the oil supply channel 28.

While air bubbles may become included in the lubricating oil sucked in by the hydraulic pump 23, the air bubbles are removed from the lubricating oil when the lubricating oil is compressed inside the hydraulic pump 23. A fixed displacement pump may be used as the hydraulic pump 23.

The optical detector 24 is disposed in the oil supply channel 28. Therefore, the optical detector 24 is positioned on the downstream side of the hydraulic pump 23 and on the upstream side of the cooler 27. That is, the optical detector 24 is disposed between the hydraulic pump 23 and the cooler 27 in the hydraulic circuit 20. In the present embodiment, the optical detector 24 is disposed on the conduit L8 which connects the hydraulic pump 23 and the brake 25.

The optical detector 24 measures the degree of contamination of the lubricating oil flowing through the oil supply channel 28 (that is, the conduit L8). The configuration of the optical detector 24 is the same as the optical detector 14 according to the first embodiment. Air bubbles in the lubricating oil flowing through the oil supply channel 28 are removed by the hydraulic pump 23. Therefore, the degree of contamination of the lubricating oil can be measured accurately because the false detection of the air bubbles as foreign matter in the lubricating oil by the optical detector 24 can be suppressed.

In addition, in the present embodiment, the optical detector 24 is positioned on the upstream side of the lubricating oil filter 26. Therefore, the mixed amount of foreign matter in the lubricating oil can be understood precisely because the optical detector 24 is able to measure the degree of contamination of the lubricating oil that has not been filtered by the lubricating oil filter 26. As a result, the degree of contamination of the lubricating oil can be measured with even greater accuracy.

The brake 25 is connected to the hydraulic pump 23 via the conduit L8. The brake 25 is positioned on the downstream sides of both the hydraulic pump 23 and the optical detector 24.

The brake 25 is a so-called wet multiplate type brake. The brake 25 has a plurality of brake disks and a plurality of fixed plates. The brake disks are aligned mutually with each of the fixed plates and braking is generated by pressure contact of both components.

The lubricating oil is supplied from the conduit L8 (that is, the oil supply channel 28) between each of the fixed plates and the brake disks of the brake 25. The lubricating oil lubricates each of the fixed plates and the brake disks.

The lubricating oil filter 26 is connected to the brake 25 via the conduit L9. The configuration of the lubricating oil filter 26 is the same as the lubricating oil filter 15 according to the first embodiment.

The cooler 27 is connected to the lubricating oil filter 26 via the conduit L10. The cooler 27 cools the lubricating oil that has been heated by the brake 25. The lubricating oil cooled by the cooler 27 is returned to the lubricating oil tank 21 via the conduit L11.

The lubricating oil is supplied to the cooler 27 from the oil supply channel 28 (specifically, the conduit L10). In the lubricating oil supplied from the oil supply channel 28 to the cooler 27, the oil pressure applied by the hydraulic pump 23 is maintained. However, in the lubricating oil flowing out from the cooler 27 to the conduit L11, the oil pressure applied by the hydraulic pump 23 is not maintained and the lubricating oil is in a pressure released state. The cooler 27 is an example of a “resisting apparatus” that maintains the oil pressure of the lubricating oil supplied from the hydraulic pump 23.

While air bubbles may be mixed into the lubricating oil discharged from the cooler 27 to the conduit L11 when returned to the lubricating oil tank 21, thereafter the air bubbles in the lubricating oil are removed when the lubricating oil is compressed by the hydraulic pump 23.

### Characteristics

(1) In the hydraulic circuit 20 according to the second embodiment, the optical detector 24 measures the degree of contamination of the lubricating oil flowing through the oil supply channel 28 which guides the lubricating oil from the hydraulic pump 23 to the cooler 27. The oil pressure of the lubricating oil flowing through the oil supply channel 28 is maintained by the cooler as a resisting apparatus. As a result, the state in which the air bubbles are removed by the hydraulic pump 23 from the lubricating oil flowing through the oil supply channel 28 is maintained. Therefore, the degree of contamination of the lubricating oil can be measured accurately because the false detection by the optical detector 24 of air bubbles as foreign matter in the lubricating oil can be suppressed.

(2) In the hydraulic circuit 20 according to the second embodiment, the optical detector 24 is positioned on the upstream side of the lubricating oil filter 26. Therefore, the mixed amount of foreign matter in the lubricating oil can be understood precisely because the optical detector 24 is able to measure the degree of contamination of the lubricating oil that has not been filtered by the lubricating oil filter 26. As a result, the degree of contamination of the lubricating oil can be measured with even greater accuracy.

### 3. Third Embodiment

### Configuration of Hydraulic Circuit 30

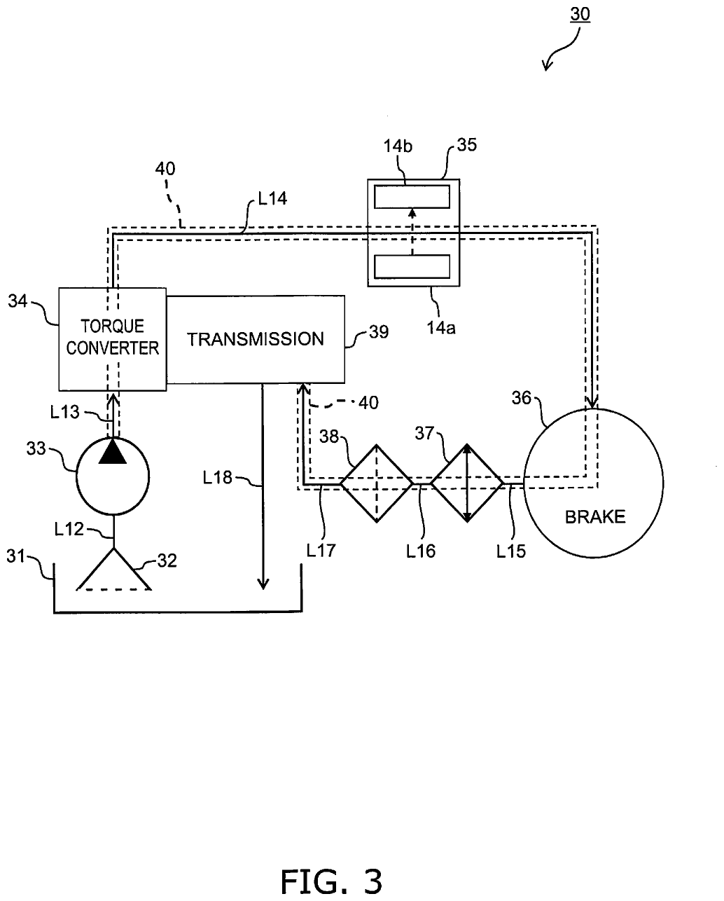

A configuration of a hydraulic circuit 30 according to a third embodiment will be explained with reference to FIG. 3. The hydraulic circuit 30 has a configuration obtained by combining the hydraulic circuit 10 according to the first embodiment and the hydraulic circuit 20 according to the second embodiment. The hydraulic circuit 30 sequentially supplies lubricating oil to both a brake 36 and a transmission 39 of a work vehicle.

The hydraulic circuit 30 is provided with a lubricating oil tank 31, a suction filter 32, a hydraulic pump 33, a torque converter 34, an optical detector 35, the brake 36, a cooler 37, a lubricating oil filter 38, the transmission 39, and conduits L12 to L18. In the present embodiment, the conduits L13 to L17, the brake 36, the cooler 37, the lubricating oil filter 38, and the transmission 39 configure an “oil supply channel 40” which guides lubricating oil from the hydraulic pump 33 to the brake 36 and the transmission 39. The oil pressure of the lubricating oil flowing is maintained in the oil supply channel 40, and pressure is applied to the lubricating oil flowing through the oil supply channel 40 by the belowmentioned hydraulic pump 33.

The configurations of the lubricating oil tank 31 and the suction filter 32 are the same as the respective lubricating oil tank 11 and the suction filter 12 according to the first embodiment.

The hydraulic pump 33 is connected to the suction filter 32 via the conduit L12. The hydraulic pump 33 is driven by rotational power from an unillustrated engine. The hydraulic pump 33 supplies the lubricating oil. Specifically, the hydraulic pump 33 sucks in the lubricating oil from the lubricating oil tank 31 side and the lubricating oil is compressed inside the hydraulic pump 33, and thereafter the lubricating oil is discharged toward the optical detector 34. The lubricating oil discharged from the hydraulic pump 33 flows through the oil supply channel 40 and is guided to the brake 36.

While air bubbles may become included in the lubricating oil sucked in by the hydraulic pump 33, the air bubbles are removed from the lubricating oil when the lubricating oil is compressed inside the hydraulic pump 33. A fixed displacement pump may be used as the hydraulic pump 33.

The torque converter 34 is connected to the hydraulic pump 33 via the conduit L13. The configuration of the torque converter 34 is the same as the torque converter 16 according to the first embodiment.

The optical detector 35 is disposed in the oil supply channel 40. Therefore, the optical detector 35 is positioned on the downstream side of the hydraulic pump 33 and on the upstream side of the transmission 39. That is, the optical detector 35 is disposed between the hydraulic pump 33 and the transmission 39 in the hydraulic circuit 30. In the present embodiment, the optical detector 35 is disposed in the conduit L14 which connects the hydraulic pump 33 and the brake 36.

The optical detector 35 measures the degree of contamination of the lubricating oil flowing through the oil supply channel 40 (specifically, the conduit L14). The configuration of the optical detector 35 is the same as the optical detector 14 according to the first embodiment. Air bubbles in the lubricating oil flowing through the oil supply channel 40 are removed by the hydraulic pump 33. Therefore, the degree of contamination of the lubricating oil can be measured accurately because the false detection by the optical detector 35 of air bubbles as foreign matter in the lubricating oil can be suppressed.

In addition, in the present embodiment, the optical detector 35 is positioned on the upstream side of the lubricating oil filter 38. Therefore, the mixed amount of foreign matter in the lubricating oil can be understood precisely because the optical detector 35 is able to measure the degree of contamination of the lubricating oil that has not been filtered by the lubricating oil filter 38. As a result, the degree of contamination of the lubricating oil can be measured with even greater accuracy.

The brake 36 is connected to the torque converter 34 via the conduit L14. The brake 36 is positioned on the downstream side of the hydraulic pump 33. In addition, the brake 36 is positioned on the upstream side of the transmission 39. The configuration of the brake 36 is the same as the brake 25 according to the second embodiment.

The cooler 37 is connected to the brake 36 via the conduit L15. The lubricating oil filter 38 is connected to the cooler 37 via the conduit L16. The configurations of the cooler 37 and the lubricating oil filter 38 are the same as the respective cooler 17 and the lubricating oil filter 15 according to the first embodiment.

The transmission 39 is connected to the lubricating oil filter 38 via the conduit L17. The transmission 39 is positioned on the downstream sides of both the hydraulic pump 33 and the optical detector 35. The configuration of the transmission 39 is the same as the transmission 18 according to the first embodiment.

Lubricating oil is supplied to the transmission 39 from the oil supply channel 40 (specifically, the conduit L17). The lubricating oil supplied to the transmission 39 is agitated by each of the gears. At this time, air bubbles are generated in the lubricating oil and the lubricating oil becomes clouded. The clouded lubricating oil is returned to the lubricating oil tank 31 via the conduit L18.

In the lubricating oil supplied from the oil supply channel 40 to the transmission 39, the oil pressure applied by the hydraulic pump 33 is maintained. However, in the lubricating oil flowing out from the transmission 39 to the conduit L18, the oil pressure applied by the hydraulic pump 33 is not maintained and the lubricating oil is in a pressure released state. The transmission 39 is an example of a “resisting apparatus” that maintains the oil pressure of the lubricating oil supplied from the hydraulic pump 33. In addition, the transmission 39 is an example of a “hydraulic apparatus” that agitates, on the inside thereof, the lubricating oil supplied from the hydraulic pump 33.

Air bubbles are mixed into the lubricating oil discharged from the transmission 39 to the conduit L18, and while air bubbles may be further mixed into the lubricating oil when returned to the lubricating oil tank 31, thereafter the air bubbles in the lubricating oil are removed when the lubricating oil is compressed by the hydraulic pump 33.

### Characteristics

(1) In the hydraulic circuit 30 according to the third embodiment, the optical detector 35 measures the degree of contamination of the lubricating oil flowing through the oil supply channel 40 for guiding the lubricating oil from the hydraulic pump 33 to the transmission 39. The oil pressure of the lubricating oil flowing through the oil supply channel 40 is maintained by the transmission 39 as a resisting apparatus. As a result, the state in which the air bubbles are removed by the hydraulic pump 33 from the lubricating oil flowing through the oil supply channel 40 is maintained. Therefore, the degree of contamination of the lubricating oil can be measured accurately because the false detection by the optical detector 35 of air bubbles as foreign matter in the lubricating oil can be suppressed.

(2) In the hydraulic circuit 30 according to the third embodiment, the optical detector 35 is positioned on the upstream side of the lubricating oil filter 38. Therefore, the mixed amount of foreign matter in the lubricating oil can be understood precisely because the optical detector 35 is able to measure the degree of contamination of the lubricating oil that has not been filtered by the lubricating oil filter 38. As a result, the degree of contamination of the lubricating oil can be measured with even greater accuracy.

(3) The optical detector 35 is disposed upstream of the transmission 39 that agitates the lubricating oil on the inside thereof. Therefore, the degree of contamination of the lubricating oil can be measured with even greater accuracy because foreign matter in the lubricating oil can be detected before the lubricating oil is agitated by the transmission 39.

### Other Embodiments

The present invention is not limited to the above embodiments and various changes and modifications may be made without departing from the spirit of the invention.

While the lubricating oil filter 15, the torque converter 16, and the cooler 17 are provided in the oil supply channel 19 of the hydraulic circuit 10 in the first embodiment, at least any one of said components may not be provided.

While the optical detectors 14, 24, and 35 in the first to third embodiments are respectively positioned on the upstream sides of the lubricating oil filters 15, 26 and 38, said optical detectors may be positioned on the downstream sides of the respective lubricating oil filters 15, 26 and 38.

While the brake 36 is positioned on the downstream side of the torque converter 34 and on the upstream side of the transmission 39 in the third embodiment, the present invention is not limited in this way. For example, the brake 36 may be disposed in parallel to the torque converter 34 and the transmission 39. In this case, the cooler 17 is preferably disposed between the torque converter 34 and the transmission 39.

While the cooler 37 is positioned on the downstream side of the lubricating oil filter 38 in the third embodiment, the cooler 37 may be positioned on the upstream side of the lubricating oil filter 38.

1. A hydraulic circuit comprising:
a hydraulic pump configured to supply lubricating oil;
a resisting apparatus configured to maintain an oil pressure of the lubricating oil supplied from the hydraulic pump;
an oil supply channel configured to guide the lubricating oil from the hydraulic pump to the resisting apparatus; and
an optical detector configured to measure a degree of contamination of the lubricating oil flowing through the oil supply channel.

2. The hydraulic circuit according to claim 1, further comprising:
a lubricating oil filter disposed along the oil supply channel,
the optical detector being positioned on an upstream side of the lubricating oil filter.

3. The hydraulic circuit according to claim 1, wherein
the resisting apparatus is a hydraulic apparatus configured to agitate the lubricating oil on an inside thereof.

4. The hydraulic circuit according to claim 3, wherein the resisting apparatus is a transmission.

5. The hydraulic circuit according to claim 1, wherein
the resisting apparatus is a cooler.
